(19) United States
(12) Patent Application Publication
(10) Pub. No.: US 2007/0210219 A1
(43) Pub. Date: Sep. 13, 2007

(54) Apparatus and method for holding a baby bottle

(76) Inventor: Heather Hiller, Bismark, AR (US)

Correspondence Address: LARSON AND LARSON, 11199 69TH STREET NORTH, LARGO, FL, 33773, US

(21) Appl. No.: 11/374,210

(22) Filed: Mar. 13, 2006

(51) Int. Cl. A61J 9/06

(52) U.S. Cl. 248/102; 446/71; 446/72; 446/77

(57) ABSTRACT

An apparatus for holding a baby bottle in a feeding position is described. The apparatus consists of a blanket having a plurality of holes through which appendages of a plush toy pass. The plush toy holds the baby bottle against the blanket and the blanket is positioned over the baby such that the baby bottle in positioned for feeding. The blanket keeps the baby warm and the blanket and the toy can be easily separated for independent use.

### BACKGROUND OF THE INVENTION

1. Field of the Invention

This invention relates to the field of holding a baby bottle during feeding and more particularly to an apparatus and method for holding a baby bottle while feeding and keeping the baby warm.

2. Description of the Related Art

For the millions of babies born each year, some are breast fed and countless others are fed by bottle. Those that are bottle fed require many feedings per day, perhaps more than five. Feeding times vary based upon the strength of the baby, the hunger of the baby and the age of the baby but usually take from 10 to 20 minutes. During this time, it is difficult for the parent or other person to do anything other than feed the baby. This task becomes even more burdensome when multiple babies are present such as in daycare situations or when parents have multiple babies of bottle feeding age.

Many devices have been invented to hold the bottle in a feeding position. Some are mechanical holders such as the “Decorative Holder for a Baby Bottle,” described in U.S. Pat. No. 6,003,821 to Fabian, etal. This class of baby bottle holder includes a stiff arm that attaches to a crib or other stationary member and a circular holder for accepting the bottle, whereby the bottle is held in position above the baby's mouth during feeding. In the '821 patent, the circular holder is disguised with an animal figure to entertain the baby while he or she eats. Unfortunately, these types of baby bottle holders require a stationary object to which they are affixed during feeding (e.g., a crib) and are useless in many feeding situations.

In other inventions, the bottle is held by the device that is draped over the baby and the device has a cavity in which the bottle is held. An example of this type of baby bottle holder is described in U.S. Pat. No. 4,895,327 to Malone, etal. These devices permit feeding in a crib and many other locations that lack a stationary fixture as required in the previous example, but have some limitations. The first limitation is lack of flexibility. This class of holders is single-purpose, in that the holder is only used for feeding, and nothing else. If the holder becomes soiled, it is out of commission while it is being cleaned. When the baby is not being fed, the holder is not useful for other purposes such as a toy or to keep the baby warm. Furthermore, these devices don't completely cover the baby and, when it is cold, the baby may require additional covering with a separate blanket.

In other inventions, the bottle is held by a device that resembles a stuffed animal. An example of this type of baby bottle holder is described in U.S. Pat. No. 5,217,192 to Oktayuren and U.S. Pat. No. 5,072,843 to James. These devices hold a baby bottle, but are easily displaced by the movement of the infant and they don't keep the baby warm. Therefore, the baby may require additional covering with a separate blanket.

In U.S. Pat. No. 4,227,270 to Rivera, the bottle is held by a pouch in a pillow case. This device may hold a baby bottle, but it is too easily displaced by the movement of the infant and it doesn't keep the baby warm. Again, the baby may require additional covering with a separate blanket.

What is needed is a device that will hold a baby bottle in a comfortable position for feeding a baby while providing a cover to keep the baby warm.

### SUMMARY OF THE INVENTION

One objective of the present invention is to provide a device that will hold a baby bottle in the feeding position while the baby drinks.

Another objective of the present invention is to provide a blanket to keep the baby warm during feeding and a toy to entertain the baby when it is finished drinking.

Another objective of the present invention is to provide a device that will hold a baby bottle using interchangeable, standard plush toys to hold the bottle, thereby allowing the caregiver the ability to provide a plush toy that is familiar to the baby.

In one embodiment, a baby bottle holder is disclosed including a plush toy having at least two appendages and a blanket having at least two holes for accepting the at least two appendages. The baby bottle is situated between the plush toy and the blanket when the at least two appendages pass through the at least two holes.

In another embodiment, a method for feeding a baby from a baby bottle is disclosed including providing a blanket having four holes for accepting two arms and two legs of a plush toy and threading each of the two arms of the plush toy through a first two of the four holes and threading each of the two legs of the plush toy through a second two of the four holes. Next, the blanket is draped over the baby so that the plush toy is substantially over the baby's chest and the plush toy lay across the baby's chest. The baby bottle is inserted between the blanket and the plush toy such that a nipple end of the baby bottle is positioned at the baby's mouth for feeding.

In another embodiment, a baby bottle holder is disclosed including a plush toy having two arms and two legs and a blanket having a first pair of holes for accepting the two arms and a second pair of holes for accepting the two legs. The plush toy is adapted to hold the baby bottle against the blanket when the two arms pass through the first pair of holes and the two legs pass through the second pair of holes.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side view of a first embodiment of the present invention.

FIG. 2 illustrates a plan view of the first embodiment of the present invention.

FIG. 3 illustrates an exploded view of the first embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

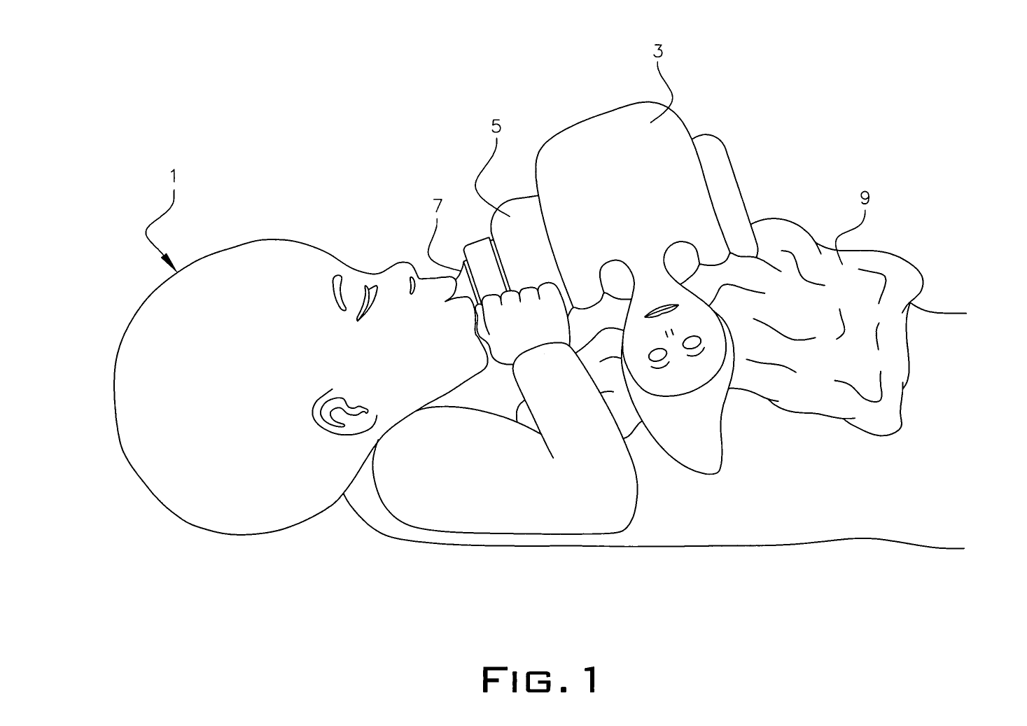

Referring to FIG. 1, a side view of a first embodiment of the present invention is shown. For completeness, a baby 1 is shown in the feeding position. The baby 1 feeds from a nipple 7 attached to the baby bottle 5. The baby bottle 5 is held in place by a plush animal 3. The plush animal 3 has appendages (arms or legs) that pass through holes in a blanket 9 that covers the chest and lower body portion of the baby 1. The plush animal 3 holds the bottle 5 which is sandwiched between the plush animal 3 and the blanket 9 during feeding. Additionally, the blanket keeps the baby 1 warm during feeding. When feeding is complete, the plush animal 3 is easily removed from the blanket 9, providing for each element to be used on its own accord. The blanket 9 is now useful for covering the baby 1 and the plush animal 3 is useful for playing and stimulation of the baby 1. By using the same plush animal 3 during play and during feeding, the baby 1 has a familiar toy during both.

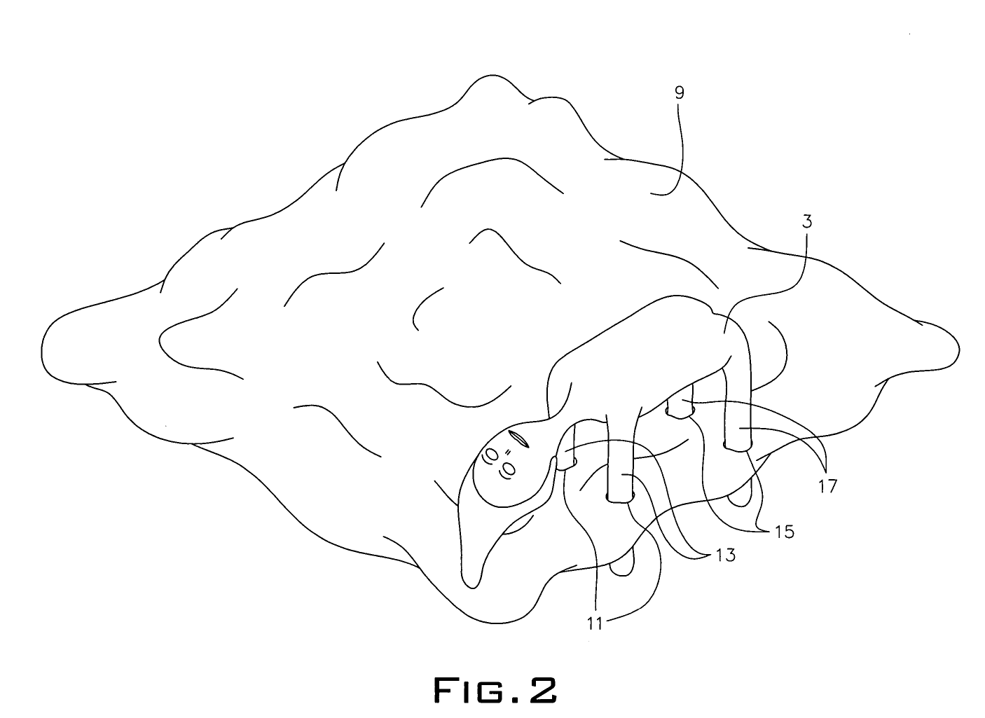

Referring to FIG. 2, a plan view of the first embodiment of the present invention is shown. The baby bottle 5 is held in place by a plush animal 3. The plush animal 3 has appendages 13/17 (arms 13 and legs 17) that pass through holes 11/15 in a blanket 9. In the preferred embodiment, the plush animal 3 is of human form having two arms 13 and two legs 17, for example a doll made from cloth and stuffed with cotton. In alternate embodiments, the plush animal 3 is any object that is capable of being threaded through two or more holes 11/15 in the blanket 9. For example, in an alternate embodiment, there are two holes 11/15 and the plush animal is a snake. It is preferred that the appendages 13/17 fit snuggly in the holes 11/15 so that the plush animal 3 holds tightly against the blanket 9, thereby holding the bottle 5 in the feeding position and preventing it from falling.

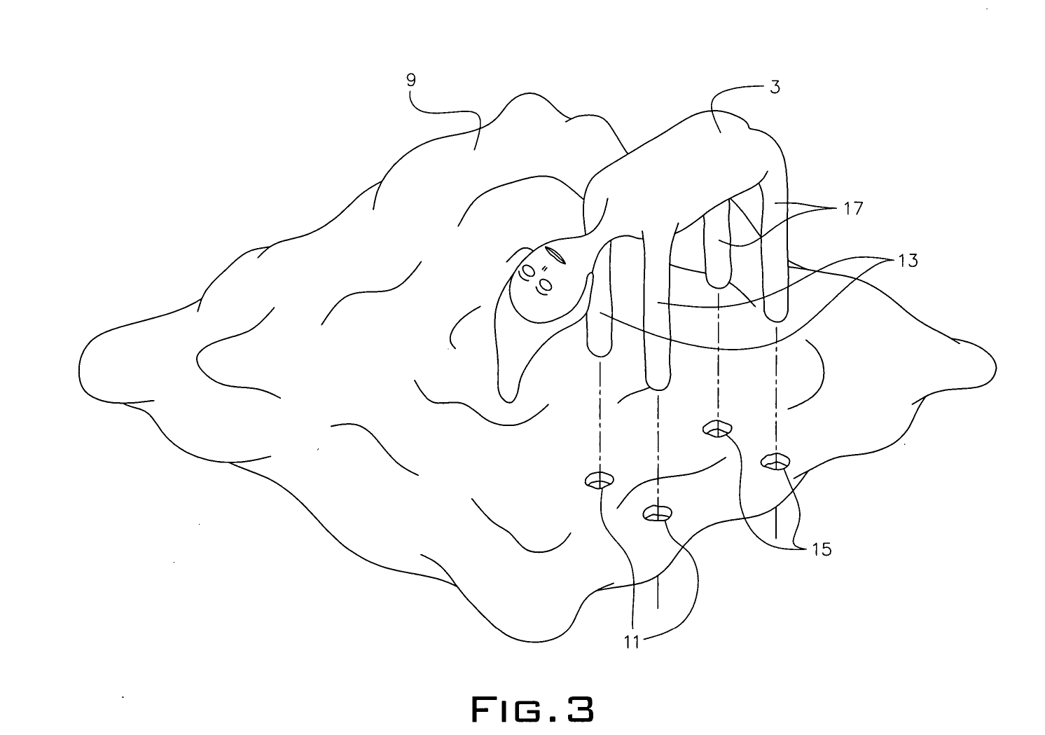

Referring to FIG. 3, an exploded view of the first embodiment of the present invention is shown. The baby bottle 5 is held in place by a plush animal 3. The plush animal 3 has appendages 13/17 (arms 13 and legs 17) that pass through holes 11/15 in a blanket 9. In the preferred embodiment, the plush animal 3 is of human form having two arms 13 and two legs 17, for example a doll made from cloth and stuffed with cotton.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A baby bottle holder comprising:
a plush toy having at least two appendages; and
a blanket having at least two holes for accepting the at least two appendages, whereas the baby bottle is situated between the plush toy and the blanket when the at least two appendages pass through the at least two holes.

2. The baby bottle holder of claim 1, wherein the plush toy is a stuffed animal in the shape of a doll.

3. The baby bottle holder of claim 1, wherein the at least two holes is four holes and the at least two appendages is two arms and two legs and the plush toy is a stuffed doll.

4. The baby bottle holder of claim 1, wherein the at least two holes is exactly two holes and the at least two appendages is exactly two appendages and the plush toy is a stuffed animal in the form of a snake.

5. A method for feeding a baby from a baby bottle comprising:
providing a blanket having four holes for accepting two arms and two legs of a plush toy;
threading each of the two arms of the plush toy through a first two of the four holes;
threading each of the two legs of the plush toy through a second two of the four holes;
draping the blanket over the baby so the plush toy is substantially over the baby's chest and the plush toy lays across the baby's chest; and
inserting the baby bottle between the blanket and the plush toy such that a nipple end of the baby bottle is positioned at the baby's mouth for feeding.

6. The method for feeding a baby of claim 5, wherein the plush toy is a stuffed animal.

7. The method for feeding a baby of claim 5, wherein the plush toy is a doll made from cloth and stuffed with cotton.

8. A baby bottle holder comprising:
a plush toy means having two arms and two legs; and
a blanket means having a first pair of holes for accepting the two arms and a second pair of holes for accepting the two legs, whereas the plush toy is adapted to hold a baby bottle, the baby bottle placed between the plush toy and the blanket when the two arms pass through the first pair of holes and the two legs pass through the second pair of holes.

9. The baby bottle holder of claim 8, wherein the plush toy means is a stuffed animal.

10. The baby bottle holder of claim 8, wherein the plush toy means is a stuffed doll made from a cloth material.
